(19) United States
(12) Patent Application Publication
(10) Pub. No.: US 2025/0066598 A1
(43) Pub. Date: Feb. 27, 2025

(54) Melt-Processable Polyvinyl Alcohol Composition, Method for Producing and Use Thereof

(71) Applicant: Nano and Advanced Materials Institute Limited, Hong Kong (HK)

(72) Inventors: Lisi HE, Hong Kong (HK); Yeuk Tin Lau, Hong Kong (HK); Man Kit CHAN, Hong Kong (HK); Jianli WANG, Hong Kong (HK); Shing Hang NG, Hong Kong (HK)

(21) Appl. No.: 18/812,557

(22) Filed: Aug. 22, 2024

Related U.S. Application Data
(60) Provisional application No. 63/578,515, filed on Aug. 24, 2023.

(51) Int. Cl. C08L 29/04; B29B 9/10; B29K 29/00; B29K 105/00; B29L 31/00; C08J 3/20; C08K 3/26; C08K 5/00; C08K 5/098; C08K 5/20; C08K 13/02

(52) U.S. Cl. CPC C08L 29/04; B29B 9/10; C08J 3/203; C08K 13/02; B29K 2003/00; B29K 2029/04; B29K 2105/0088; B29K 2995/006; B29L 2031/712; C08J 2329/04; C08J 2403/02; C08J 2425/14; C08J 2467/02; C08J 2467/04; C08K 2003/265; C08K 5/005; C08K 5/098; C08K 5/20; C08L 2201/06; C08L 2201/08; C08L 2203/16; C08L 2203/30; C08L 2205/035; C08L 2205/06; C08L 2205/08; C08L 2207/322

(57) ABSTRACT

The present invention provides a polyvinyl alcohol composition comprising polyvinyl alcohol, plasticizer, and one or more components selected from the group consisting of biodegradable polymer, compatibilizer, surfactant, antioxidant, and properties modifier. The polyvinyl alcohol composition of the present application is melt-processable, biodegradable and water-soluble. The present invention also relates to the method for producing the polyvinyl alcohol composition, and the use of the same.

### CROSS-REFERENCE TO RELATED APPLICATIONS

This application claims benefit under 35 U.S.C. 119 (e) of US Provisional Application having Ser. No. 63/578,515 filed on 24 Aug. 2023, the entire contents of which is/are hereby incorporated by reference herein.

### FIELD OF INVENTION

The present invention relates to melt-processable polyvinyl alcohol composition, which is also biodegradable and water-soluble. The present invention also relates to the method for producing the polyvinyl alcohol composition, and the use of the same.

### BACKGROUND OF INVENTION

Polyvinyl alcohol (PVA) not only is biodegradable, but is also able to dissolve in room temperature water and does not pose safety risks to the environment, which makes PVA become more and more popular in the market. However, the current application of PVA is still limited due to the fact of poor processability that PVA raw material is unplasticized and it's not melt-processable, which cannot be applied in common production process in plastic industry, such as extrusion, injection molding, extrusion film casting, film blowing, etc. For example, the PVA films in the market and in literature are normally using solvent casting process, which is less effective, and more expensive than film blowing process, the commonly used technique in industry.

Therefore, there are many studies focusing on the development of plasticized PVA by plasticizers, cross-linking, and blending compositions. U.S. Pat. No. 4,119,604 disclosed a PVA composition with a copolymer of vinyl alcohol and ethylenically unsaturated ester and polyethylene glycol for the preparation of blown films which is soluble in 20° C. water, however, it fails to disclose details for other melt-process application such as melt-flow index and controlled water-solubility, such as improve water resistance for injection molding. U.S. Pat. No. 5,137,969 disclosed a method for extruding PVA composition with phosphoric acid, sodium acetate and polyhydric low molecular weight alcohol with reduced maximum melt temperature by controlling the pre-mixing and cooling and energy input during the compounding, however, it fails to disclose details for melt-process applications, and fails to disclose water solubility after the modification for melt-processability. U.S. Pat. No. 4,542,178 disclosed a method to prepare plasticizer-containing polyvinyl alcohol granules which comprised 10 to 30% plasticizers and contained 2 to 12% high molecular weight organic compounds such as starch, polyvinyl ester and polyvinyl acetal, in a form of aqueous dispersion to form agglomerates before extrusion, however, it fails to disclose details for melt-process applications and also fails to disclose water solubility after the modification for melt-processability. CN patent CN106380765 disclosed a water soluble shopping bag and its production method, which comprised polyvinyl alcohol and a mixed of plasticizers and additives such as alkyl polyglycosides, polyhydric alcohol ethers, polyethylene oxide lubricants, however, other than film blowing, it fails to disclose other melt-process applications. WIPO patent WO 2014155059 disclosed a water soluble polymer and polymer internal lubricant comprising a blend of water soluble polymer such as polyvinyl alcohol and 15% or more and up to 75% hygroscopic salts as lubricants, however, it fails to disclose other melt-process applications such as film blowing. In some applications, such as injection molding products, temperature controlled water solubility may be preferred for better usability, which means that the product has a better water resistance under room temperature (e.g. 25° C.) for better usability and when it can be dissolve in high temperature water (e.g. 90° C.) for better disposability. U.S. Pat. No. 4,567,221 disclosed water resistant compositions which comprised a modified polyvinyl alcohol having a silyl group in the molecule and a copolymer of a vinyl ester and olefinically unsaturated monomer having a silyl group in the molecule, however, its approach permanently modified the molecular structure of polyvinyl alcohol and fails to disclose the water solubility for disposability, and also fails to disclose the melt-process applications.

Also, biodegradability and the food contact safe aspect of the PVA based compositions after modification for melt-processability, and other practical use of the end products are not considered in the prior arts.

Therefore, there is a need for a formulation/method to develop melt-processable PVA based materials with control water solubility, biodegradability, biocompatibility and food contact safety for better usability and more environmental friendly.

### SUMMARY OF INVENTION

The present invention provides a polyvinyl alcohol composition comprising polyvinyl alcohol, plasticizer, and one or more components selected from the group consisting of biodegradable polymer, compatibilizer, surfactant, antioxidant, and properties modifier.

The polyvinyl alcohol composition of the present application is melt-processable, biodegradable and water-soluble.

The present invention also relates to the method for producing the polyvinyl alcohol composition.

The present invention also provides use of the melt-processable polyvinyl alcohol composition in producing films by film blowing and extrusion film casting, and use of the melt-processable polyvinyl alcohol composition in producing solid stick by extrusion molding to obtain solid stick.

### BRIEF DESCRIPTION OF FIGURES

FIG. 1 schematically depicts the methods of producing melt-processable PVA based pellets from PVA raw materials in powder form.

FIGS. 2A-2D show the use of the melt-processable PVA based material in film blowing for cling films (FIG. 2B), plastic bags (FIG. 2C) and agriculture film (FIG. 2D).

FIGS. 3A-3B show different use of melt-processable PVA based materials in extrusion film casting for PVA based films.

FIG. 4A-4B shows the use of the melt-processable PVA based material in extrusion molding for solid stick (FIG. 4A), and its resistance to room-temperature (25° C.) water (FIG. 4B).

FIG. 5 shows use of the melt-processable PVA based material in injection molding.

FIG. 6 shows food contact safety test report of the PVA based cling film in FIG. 2B.

FIG. 7 shows food contact safety reports of the PVA based solid stick in FIG. 4A.

### DETAILED DESCRIPTION

Various terms relating to aspects of the present disclosure are used throughout the specification and claims. Such terms are to be given their ordinary meaning in the art, unless otherwise indicated. Other specifically defined terms are to be construed in a manner consistent with the definitions provided herein.

As used herein, the singular forms “a,” “an” and “the” include plural referents unless the context clearly dictates otherwise.

As used herein, the term “about” means that the recited numerical value is approximate and small variations would not significantly affect the practice of the disclosed embodiments. Where a numerical value is used, unless indicated otherwise by the context, the term “about” means the numerical value can vary by +10% and remain within the scope of the disclosed embodiments.

As used herein, the term “comprising” may be replaced with “consisting” or “consisting essentially of” in particular embodiments as desired.

As used herein, the term “film” means single layer unsupported sheets having a thickness in the range between 0.5 and 10 mils, and it does not include laminates or coatings.

The present invention provides a melt-processable polyvinyl alcohol composition, comprising:
(1) polyvinyl alcohol as the major component,
(2) a plasticizer for increasing the plasticity of polyvinyl alcohol to achieve melt-processability, and
(3) one or more components selecting from the group consisting of:
(a) a biodegradable polymer to improve water resistance and maintain biodegradability,
(b) a compatibilizer to provide cross-linkage and increase the compatibility between the components,
(c) a surfactant for promoting the interaction of the components with different polarity to improve the compatibility of the component in the composition,
(d) an antioxidant for inhibiting oxidation reaction during the melt-processing, and
(e) a properties modifier for providing specific properties for different applications.

The composition of the present invention comprises polyvinyl alcohol as the major component.

In a preferred embodiment of the present invention, the polyvinyl alcohol is raw material in powder, chip or flake form, and it is in an amount of 60-95 wt %. Preferably, the polyvinyl alcohol is in an amount of 85-94 wt %.

The composition of the present invention also comprises a plasticizer for increasing the plasticity of polyvinyl alcohol to achieve melt-processability. The plasticizer may be any chemical agent added to the composition to improve its flow and processability and to reduce brittleness.

In a preferred embodiment of the present invention, the plasticizer comprises water, glycerol, ethylene glycol, polyethylene glycol, Tung oil anhydride, epoxidized soybean oil, triethyl citrate, and acetyl triethyl citrate, or any combination thereof; and it is in an amount of 0-10 wt %. Preferably, the plasticizer is epoxidised soyabean oil or water, and it is in an amount of 6-7 wt %.

The composition of the present invention may comprise a biodegradable polymer to improve water resistance and maintain biodegradability. The biodegradable polymer may be attacked by a biological environment so that the integrity of the polymer is affected and produces degradation fragments.

In a preferred embodiment of the present invention, the biodegradable polymer comprises cellulose, starch, polylactic acid (PLA), polyhydroxyalkanoates (PHAs), polybutylene succinate (PBS), polycaprolactone (PCL), polybutylene adipate terephthalate (PBAT), polyglycolic acid (PGA), and poly(lactic-co-glycolic acid)(PLGA), or any combination thereof; and it is in an amount of 0-30 wt %. Preferably, the biodegradable polymer is polylactic acid (PLA), polybutylene adipate terephthalate (PBAT) or starch, and it is in an amount of 2-15 wt %.

The composition of the present invention may comprise a compatibilizer to provide cross-linkage and increase the compatibility between the components. The compatibilizer facilitates formation of uniform blends of normally immiscible polymers with desirable end properties.

In a preferred embodiment of the present invention, the compatibilizer comprises modified styrene acrylic polymers (ADR), lactic acid, ethylene glycol, and 1,4-butanediol, maleic anhydride, Tung oil anhydride, epoxidized soybean oil, methylene-diphenyldiisocyanate, acrylic acid, and citric acid; or any combination thereof; and it is in an amount of 0-5 wt %. Preferably, the compatibilizer is ADR, and it is in an amount of 0.5-1 wt %.

The composition of the present invention may comprise a surfactant, which reduces the surface tension of a liquid. The surfactant promotes the interaction of the components with different polarity to improve the compatibility of the component in the composition.

In a preferred embodiment of the present invention, the surfactant comprises polysorbates, sorbitan esters, and alkylphenol ethoxylates; ammonium lauryl sulfate, sodium lauryl sulfate, perfluorooctanesulfonate, perfluorobutanesulfonate, alkyl-aryl ether phosphates, alkyl ether phosphates sodium dodecylbenzenesulfonate, sodium dodecyl sulfate, sodium stearate, calcium stearate, dioctadecyldimethylammonium, lauryldimethylamine oxide, myristamine oxide, glycolipids, phospholipids, lipopeptides, neutral lipids, fatty acids, Tween 80, and lipopolysaccharides; or any combination thereof; and it is in an amount of 0-5 wt %.

Preferably, the surfactant is calcium stearate or Tween 80, and it is in an amount of 1 wt %.

The composition of the present invention may comprise an antioxidant for inhibiting oxidation reaction during the melt-processing.

In a preferred embodiment of the present invention, the antioxidant comprises ascorbic acid, tocopherols, glutathione, tetrakis [methylene (3,5-di-t-butyl-4-hydroxyhydrocinnamate)] methane, tris (2,4-di-tert-butylphenyl) phosphite, lipoic acid, and uric acid, or any combination thereof; and it is in an amount of 0-1 wt %.

The composition of the present invention may comprise a properties modifier for providing specific properties for different applications.

In a preferred embodiment of the present invention, the properties modifier comprises calcium carbonate, titanium dioxide, oleamide, talcum powder, organomontmorillonite, bentonite, nanofillers, natural fiber, color masterbatch, and scent masterbatch, or any combination thereof; and it is in an amount of 0-20 wt %. Preferably, the properties modifier is calcium carbonate or oleamide, and it is in an amount of 0.5-6 wt %.

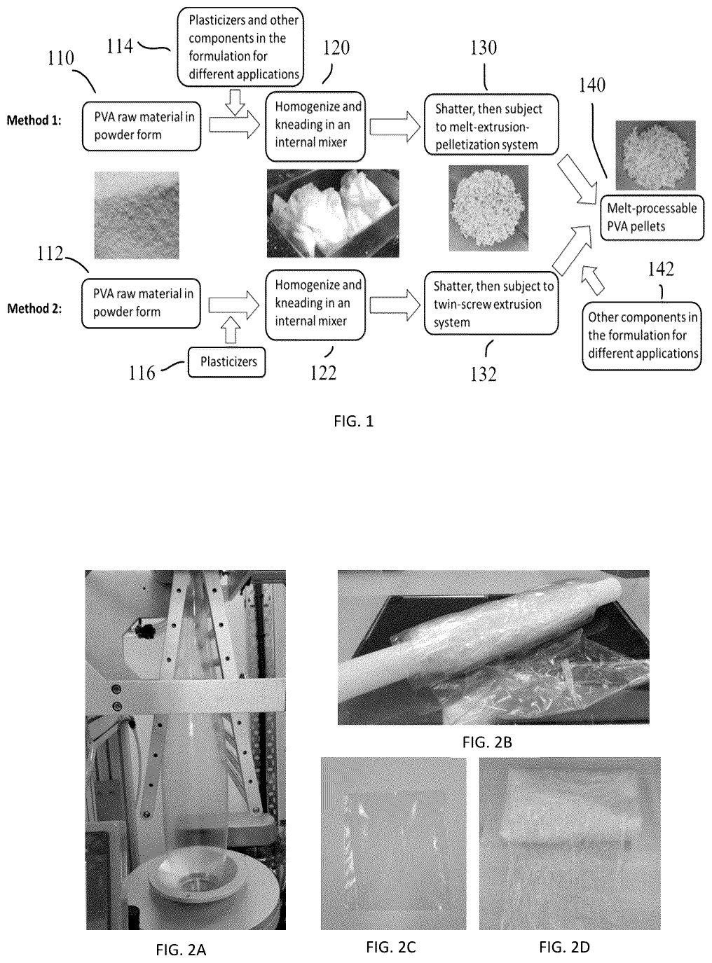

Referring to FIG. 1, the present invention also provides a method for producing the melt-processable polyvinyl alcohol composition. The method comprises: homogenizing the polyvinyl alcohol, plasticizers and other components in the formulation for different applications (114) in an internal mixer and kneading at a first elevated temperature to obtain a dough like composition (120); shattering the dough like composition into small pieces and subjecting the small pieces to a melt-extrusion-pelletization system under a second elevated temperature (130) to obtain the melt-processable polyvinyl alcohol based pellets (140). In one embodiment, the polyvinyl alcohol raw material is in powder form (110).

The present invention also provides a method for producing the melt-processable polyvinyl alcohol composition, comprising: homogenizing the polyvinyl alcohol and plasticizers (116) in an internal mixer and kneading at a first elevated temperature to obtain a dough like plasticized polyvinyl alcohol (122); shattering the dough like plasticized polyvinyl alcohol into small pieces and subjecting the small pieces to a twin-screw extrusion system under a second elevated temperature (132) with other components in the formulation for different applications (142) to obtain the melt-processable polyvinyl alcohol based pellets (140). In one embodiment, the polyvinyl alcohol raw material is in powder form (112).

Preferably, the first elevated temperature ranges from 150° C. to 210° C., and the second elevated temperature ranges from 160° C. to 200° C.

The present invention also provides the use of the melt-processable polyvinyl alcohol composition in producing films by film blowing and extrusion film casting. Preferably, the films are cling film, plastic bag, and agricultural film.

The produced polyvinyl alcohol based cling film, plastic bag, and agricultural film can be dissolved in room temperature water (20-30° C.).

The produced polyvinyl alcohol based cling film, plastic bag, and agricultural film are biodegradable with 69.89%, 62.26%, and 73.07% biodegradation at Day 45, and 89.47%, 84.92%, and 92.20% biodegradation at Day 90, respectively under the ASTM D5511 tests conducted by Intertek.

The produced polyvinyl alcohol based cling film fulfills the food contact safety test according to the migration test of US FDA 21 CFR 176.170.

The temperature for the film blowing process and extrusion film casting process ranges from 170° C. to 200° C. using a film blowing machine and extrusion film casting machine, respectively.

The present invention also provides the use of the melt-processable polyvinyl alcohol composition in producing solid stick by extrusion molding to obtain solid stick.

The produced polyvinyl alcohol based solid stick can be controlled to have a water resistance in room temperature water (20-30° C.), with weight loss less than 5% in water after 24 hours, and it can be dissolved in hot water (90-100° C.).

The produced polyvinyl alcohol based solid stick is biodegradable with 85.35% biodegradation at Day 90 under the ASTM D5511 tests conducted by Intertek.

The produced polyvinyl alcohol based solid stick fulfills the food contact safety test according to the migration test of US FDA 21 CFR 176.170.

The temperature for the extrusion molding process ranges from 170° C. to 200° C. using an extrusion molding machine.

The melt-processable polyvinyl alcohol composition of the present invention can be applied in injection molding and the temperature for the extrusion molding process ranges from 190° C. to 210° C. using an injection molding machine.

The polyvinyl alcohol injection molded product of the present invention can be controlled to have a water resistance in room temperature water (20-30° C.), with weight loss less than 5% in water after 24 hours, and it can be dissolved in hot water (90-100° C.).

The polyvinyl alcohol based extrusion molding and injection molding products of the present invention can be controlled to have a melt flow index from 0.21 to 6.0 g/10 min under 200° C. and 5 kg.

In the present invention, PVA raw material is the major component with no less than 85 wt %.

The plasticizer is no more than 10 wt % and water is used as plasticizer, and avoid to use larger amounts of small molecule plasticizer such as glycerol to minimize the migration to achieve food contact safe of the film, according to the migration test of US FDA 21 CFR 176.170.

The films are designed to be soluble in room temperature water (20-30° C.), such as application in laundry bag, which can be completely soluble during laundry. And it can be applied in agriculture film for protecting plant root and direct planting, i.e. PVA film to protect the root and pre-pack the fertilizers, and planting directly without removing the film for protecting the root and keeping the pre-applied fertilizers, after planting in soil, water will be applied and the PVA film will be dissolved. And component in the formulation is considered in related application, for example, calcium carbonate is added in agriculture film.

The transparency of the film can be controlled from 50% to 90% by different formulations for different applications.

The mechanical properties of the film can be controlled by different formulations for different applications: tensile strength from 15 to 35 MPa, elongation at break from 145% to 300%.

The films with different formulation for different applications are biodegradable with 69.89% to 73.07% biodegradation at Day 45, and 84.92% to 92.20% biodegradation at Day 90, under the ASTM D5511 tests conducted by Intertek; and passed OECD 301B biodegradation test conducted by Intertek, which is an aqueous aerobic biodegradation test that determines the ready biodegradability of a material by measuring CO₂ evolution during biodegradation with passing requirement is 28 Day biodegradation 60% or more.

The film is biocompatible (low toxicity) demonstrated by OECD 201 and OECD 203 tests conducted by Intertek to verify the toxicity to the environment after dissolving in water during disposal.

The composition of the present invention is suitable for injection molding and extrusion molding, because it has the following features:

1) PVA raw material is the major component with no less than 65 wt %.

2) The plasticizer is no more than 10 wt % and using water as plasticizer, and avoid to use larger amounts of small molecule plasticizer such as glycerol to minimize the migration to achieve food contact safe, according to the migration test of US FDA 21 CFR 176.170.

3) The products are designed to have water resistance in room temperature water (20-30° C.) with weight loss less than 5% in water after 24 hours, but it can be dissolved in hot water (90-100° C.) for disposability in water.

7 The melt flow index can be controlled from 0.21 to 6.0 g/10 min under 200° C. and 5 kg for the application of extrusion molding and injection molding products by the formulation design such as the type and amount of biodegradable polymer, and the type and amount of compatibilizer.

5) The mechanical properties can be controlled by different formulations for different applications: tensile strength from 35 to 81 MPa, elongation at break from 10% to 26%.

6) PVA based solid stick is biodegradable with 85.35% biodegradation at Day 90 under the ASTM D5511 tests conducted by Intertek; and passed OECD 301B biodegradation test conducted by Intertek, which is an aqueous aerobic biodegradation test that determines the ready biodegradability of a material by measuring CO₂ evolution during biodegradation with passing requirement is 28 Day biodegradation 60% or more.

All of the raw materials and machines used in the present invention are available commercially.

### EXAMPLES

### Example 1

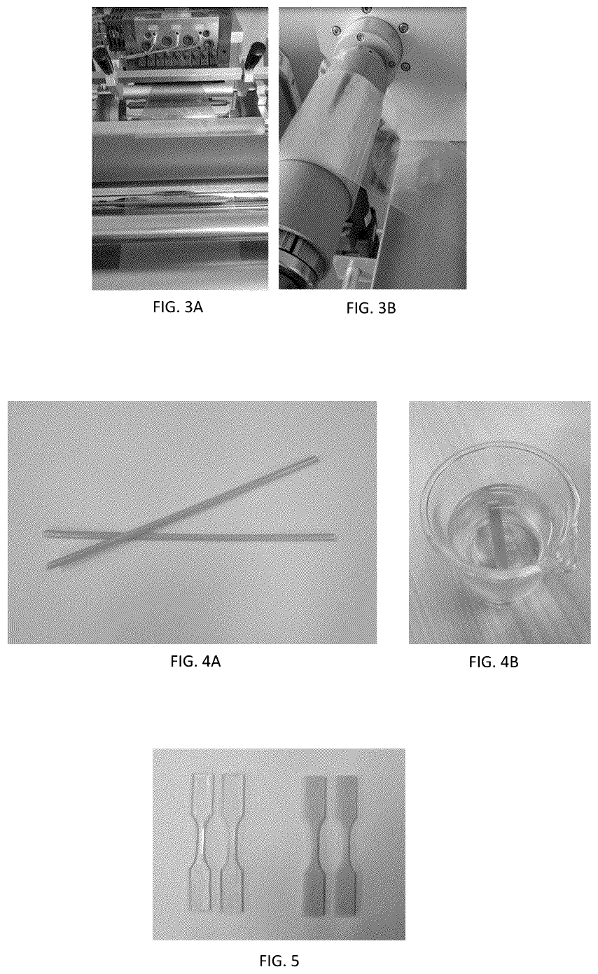

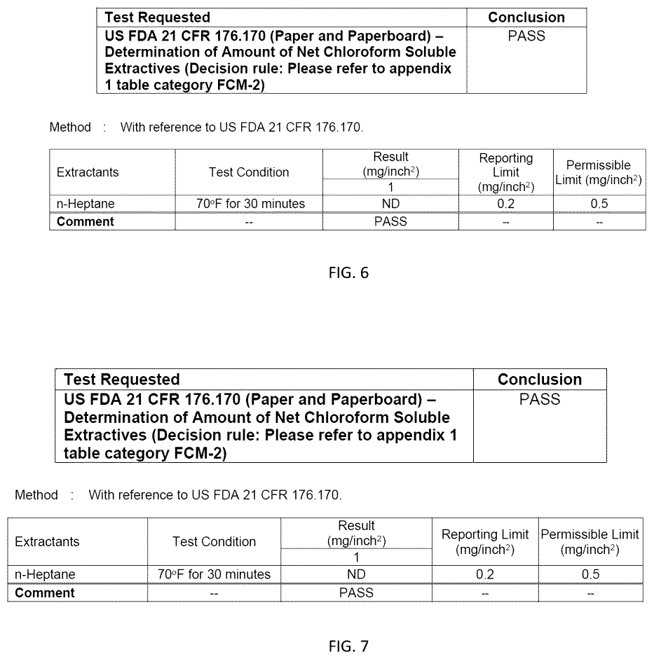

PVA powder (91 wt %), water (6 wt %), PBAT (2 wt %), oleamide (0.5 wt %), ADR (0.5 wt %) were mixed and kneaded in an internal mixer under 190° C., 40 rpm, for 15 min to obtain a dough like composition, which was then shattered into small pieces and subjected to a melt-extrusion-pelletization system under 175° C., 25 rpm to obtain the pellets. The pellets were applied in a single screw extruder with a film blowing system (180-200° C.) to obtain blown film as shown in FIG. 2A, or with a film casting system (180-200° C.) to obtain casting film as shown in FIGS. 3A-B, which can be applied as cling film (0.01 mm thickness) and plastic bag such as laundry bag (0.04 mm thickness), as shown in FIGS. 2B and 2C, respectively. The cling film obtained is with 35 MPa tensile strength, and 190% elongation at break, and 90% transparency. And the plastic laundry bag obtained is with 35 MPa tensile strength and 280% elongation at break, and 85% transparency. The PVA film/bags are soluble in room temperature water (20-30° C.). And the PVA film is biodegradable with 69.89% (for cling film) and 62.26% (for laundry bag) biodegradation at Day 45, and with 89.47% (for cling film) and 84.92% (for laundry bag) biodegradation at Day 90, under the ASTM D5511 tests conducted by Intertek; and passed OECD 301B biodegradation test conducted by Intertek, which is an aqueous aerobic biodegradation test that determines the ready biodegradability of a material by measuring CO₂ evolution during biodegradation with passing requirement is 28 Day biodegradation 60% or more. The cling film also fulfills the food contact safety test according to the migration test of US FDA 21 CFR 176.170. The film is biocompatible (low toxicity) demonstrated by OECD 201 and OECD 203 tests conducted by Intertek to verify the toxicity to the environment after dissolving in water during disposal.

### Example 2

PVA powder (85 wt %), water (6 wt %), calcium carbonate (6 wt %), PBAT (2 wt %), calcium stearate (1 wt %) were mixed and kneaded in an internal mixer under 195° C., 40 rpm, for 10 min to obtain a dough like composition, which was then shattered into small pieces and subjected to a melt-extrusion-pelletization system under 170° C., 25 rpm to obtain the pellets. The pellets were applied in a single screw extruder with a film blowing system (180-200° C.) to obtain blown film as shown in FIG. 2D, which can be applied in agricultural film. The agricultural film obtained is with 15 MPa tensile strength, and 145% elongation at break, and 50% transparency. The PVA film/bags are soluble in room temperature water (20-30° C.). And the PVA film is biodegradable with 73.07% biodegradation at Day 45, and with 92.20% biodegradation at Day 90, under the ASTM D5511 tests conducted by Intertek; and passed OECD 301B biodegradation test conducted by Intertek, which is an aqueous aerobic biodegradation test that determines the ready biodegradability of a material by measuring CO₂ evolution during biodegradation with passing requirement is 28 Day biodegradation 60% or more.

### Example 3

PVA powder (94 wt %), water (6 wt %) were mixed and kneaded in an internal mixer under 195° C., 40 rpm, for 10 min to obtain a dough like composition, which was then shattered into small pieces and subjected to a melt-extrusion-pelletization system under 170° C., 25 rpm to obtain the pellets. And the PVA pellet (73 wt %) was mixed with PLA (15 wt %), starch (8 wt %), ESBO (7 wt %), Tween 80 (1 wt %), ADR (1 wt %), and applied in a twin screw extruder (170-200° C.) to produce extrusion molding solid stick as shown in FIG. 4 or to produce pellets for injection molding (190-210° C.) to produce injection molded products as shown in FIG. 5. The solid stick obtained have water resistance in room temperature water (20-30° C.) with weight loss less than 5% in water after 24 hours, but it can be dissolved in hot water (90-100° C.) for disposability in water. It has a melt flow index 5.12 g/10 min under 200° C. and 5 kg, and it has 85.35% biodegradation at Day 90 under the ASTM D5511 tests conducted by Intertek; and passed OECD 301B biodegradation test conducted by Intertek, which is an aqueous aerobic biodegradation test that determines the ready biodegradability of a material by measuring CO₂ evolution during biodegradation with passing requirement is 28 Day biodegradation 60% or more. And it also fulfills the food contact safety test according to the migration test of US FDA 21 CFR 176.170.

Various modifications of the described subject matter, in addition to those described herein, will be apparent to those skilled in the art from the foregoing description. Such modifications are also intended to fall within the scope of the appended claims.

What is claimed is:

1. A melt-processable polyvinyl alcohol composition, comprising:
a polyvinyl alcohol, and
a plasticizer for increasing the plasticity of polyvinyl alcohol to achieve melt-processability, and one or more components selected from the group consisting of:
a biodegradable polymer to improve water resistance and maintain biodegradability,
a compatibilizer to provide cross-linkage and increase the compatibility between the components,
a surfactant for promoting the interaction of the components with different polarity to improve the compatibility of the component in the composition,
an antioxidant for inhibiting oxidation reaction during the melt-processing, and
a properties modifier for providing specific properties for different applications.

2. The melt-processable polyvinyl alcohol composition of claim 1, wherein the polyvinyl alcohol is raw material in powder, chip, or flake form; and the polyvinyl alcohol is in an amount of 60-95 wt %.

3. The melt-processable polyvinyl alcohol composition of claim 1, wherein the plasticizer comprises water, glycerol, ethylene glycol, polyethylene glycol, Tung oil anhydride, epoxidized soybean oil, triethyl citrate, acetyl triethyl citrate, or any combination thereof; and the plasticizer is in an amount of 0-10 wt %.

4. The melt-processable polyvinyl alcohol composition of claim 1, wherein the plasticizer is epoxidised soyabean oil or water.

5. The melt-processable polyvinyl alcohol composition of claim 1, wherein the plasticizer is in an amount of 6-7 wt %.

6. The melt-processable polyvinyl alcohol composition of claim 1, wherein the biodegradable polymer comprises cellulose, starch, polylactic acid (PLA), polyhydroxyalkanoates (PHAs), polybutylene succinate (PBS), polycaprolactone (PCL), polybutylene adipate terephthalate (PBAT), polyglycolic acid (PGA), poly(lactic-co-glycolic acid)(PLGA), or any combination thereof; and the biodegradable polymer is in an amount of 0-30 wt %.

7. The melt-processable polyvinyl alcohol composition of claim 1, wherein the biodegradable polymer is polylactic acid (PLA), polybutylene adipate terephthalate (PBAT), or starch.

8. The melt-processable polyvinyl alcohol composition of claim 1, wherein the biodegradable polymer is in an amount of 2-15 wt %.

9. The melt-processable polyvinyl alcohol composition of claim 1, wherein the compatibilizer comprises modified styrene acrylic polymers (ADR), lactic acid, ethylene glycol, and 1,4-butanediol, maleic anhydride, Tung oil anhydride, epoxidized soybean oil, methylene-diphenyldiisocyanate, acrylic acid, citric acid; or any combination thereof; and the compatibilizer is in an amount of 0-5 wt %.

10. The melt-processable polyvinyl alcohol composition of claim 1, wherein the compatibilizer is ADR.

11. The melt-processable polyvinyl alcohol composition of claim 1, wherein the compatibilizer is in an amount of 0.5-1 wt %.

12. The melt-processable polyvinyl alcohol composition of claim 1, wherein the surfactant comprises polysorbates, sorbitan esters, and alkylphenol ethoxylates; ammonium lauryl sulfate, sodium lauryl sulfate, perfluorooctanesulfonate, perfluorobutanesulfonate, alkyl-aryl ether phosphates, alkyl ether phosphates sodium dodecylbenzenesulfonate, sodium dodecyl sulfate, sodium stearate, calcium stearate, dioctadecyldimethylammonium, lauryldimethylamine oxide, myristamine oxide, glycolipids, phospholipids, lipopeptides, neutral lipids, fatty acids, Tween 80, lipopolysaccharides; or any combination thereof; and the surfactant is in an amount of 0-5 wt %.

13. The melt-processable polyvinyl alcohol composition of claim 1, wherein the surfactant is calcium stearate or Tween 80.

14. The melt-processable polyvinyl alcohol composition of claim 1, wherein the surfactant is in an amount of 1 wt %.

15. The melt-processable polyvinyl alcohol composition of claim 1, wherein the antioxidant comprises ascorbic acid, tocopherols, glutathione, tetrakis [methylene (3,5-di-t-butyl-4-hydroxyhydrocinnamate)] methane, tris (2,4-di-tert-butylphenyl) phosphite, lipoic acid, uric acid, or any combination thereof; and the antioxidant is in an amount of 0-1 wt %.

16. The melt-processable polyvinyl alcohol composition of claim 1, wherein the properties modifier comprises calcium carbonate, titanium dioxide, oleamide, talcum powder, organomontmorillonite, bentonite, nanofillers, natural fiber, color masterbatch, scent masterbatch, or any combination thereof; and the properties modifier is in an amount of 0-20 wt %.

17. The melt-processable polyvinyl alcohol composition of claim 1, wherein the properties modifier is calcium carbonate or oleamide.

18. The melt-processable polyvinyl alcohol composition of claim 1, wherein the properties modifier is in an amount of 0.5-6 wt %.

19. A method for producing the melt-processable polyvinyl alcohol composition of claim 1, comprising: homogenizing the polyvinyl alcohol, plasticizers and other components in the formulation for different applications in an internal mixer and kneading at a first elevated temperature to obtain a dough like composition; shattering the dough like composition into small pieces; and subjecting the small pieces to a melt-extrusion-pelletization system under a second elevated temperature to obtain the melt-processable polyvinyl alcohol based pellets.

20. A method for producing the melt-processable polyvinyl alcohol composition of claim 1, comprising: homogenizing the polyvinyl alcohol and plasticizers in an internal mixer and kneading at a first elevated temperature to obtain a dough like plasticized polyvinyl alcohol; shattering the dough like plasticized polyvinyl alcohol into small pieces; and subjecting the small pieces to a twin-screw extrusion system under a second elevated temperature with other components in the formulation for different applications to obtain the melt-processable polyvinyl alcohol based pellets.
